(19) United States
(12) Patent Application Publication
(10) Pub. No.: US 2019/0186148 A1
(43) Pub. Date: Jun. 20, 2019

(54) ROOF CLEANING DEVICE

(71) Applicant: Luke Pastre, Pinehurst, NC (US)

(72) Inventor: Luke Pastre, Pinehurst, NC (US)

(21) Appl. No.: 15/845,494

(22) Filed: Dec. 18, 2017

(51) Int. Cl. E04D 15/00; A47L 11/38; B08B 5/00

(52) U.S. Cl. CPC E04D 15/006; B08B 5/00; A47L 11/38

(57) ABSTRACT

A roof cleaning device. The roof cleaning device includes at least a blower and an elongated tube. The blower includes a housing, a motor disposed in the housing, and a blower nozzle. The elongated tube includes a proximal end and a distal end. The proximal end is coupled to the blower nozzle to receive the air from the blower and the distal end includes an opening. The motor is operable to propel air out of the nozzle, into the elongated tube and out of the opening of the distal end of the elongated tube.

### BACKGROUND OF THE INVENTION

The present invention relates to a roof cleaning device and, more particularly, to a blower used to clean roofs from the ground.

The pitch of a roof is its vertical rise divided by its horizontal span, or what is called slope. Cleaning debris, such as leaves and dirt, from a roof having a high pitch is dangerous. Typically, to clean a roof one must climb on top of the roof to remove the debris. Due to the pitch of the roof, one risks falling off of the roof and severely injuring themselves or even dying.

As can be seen, there is a need for a device that allows a user to clean roofs that have a high pitch from the ground.

### SUMMARY OF THE INVENTION

In one aspect of the present invention, a roof cleaning device comprises: a blower comprising a housing, a motor disposed in the housing, and a blower nozzle, wherein the motor is operable to propel air out of the nozzle; an elongated tube comprising a proximal end and a distal end, wherein the proximal end is coupled to the blower nozzle to receive the air from the blower and the distal end comprises an opening; and a bracket coupled to the distal end of the elongated tube, wherein the bracket comprises at least one roller.

In another aspect of the present invention, a roof cleaning device comprises: a blower comprising a housing, a motor disposed in the housing, and a blower nozzle, wherein the motor is operable to propel air out of the nozzle; and an elongated tube comprising a proximal end and a distal end, wherein the proximal end is coupled to the blower nozzle to receive the air from the blower and the distal end comprises an opening, wherein a bend greater than 90 degrees is formed at the distal end of the elongated tube.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded perspective view of an embodiment of the present invention;

FIG. 2A is a detail exploded perspective view of an embodiment of the present invention;

FIG. 3 is a detail perspective view of an embodiment of the present invention;

FIG. 4 is a cross section view taken along line 4-4 of FIG. 3; and

FIG. 5 is a detail perspective view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

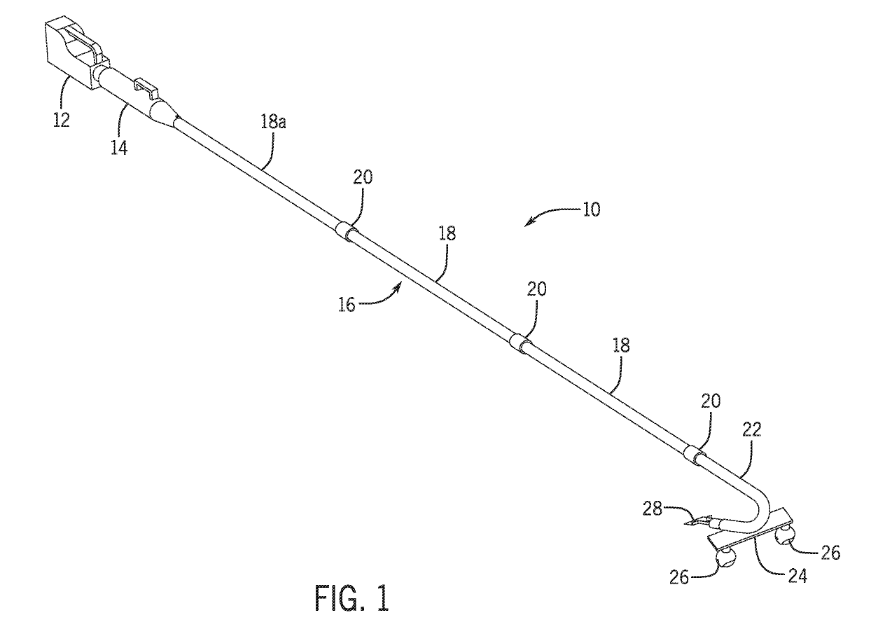

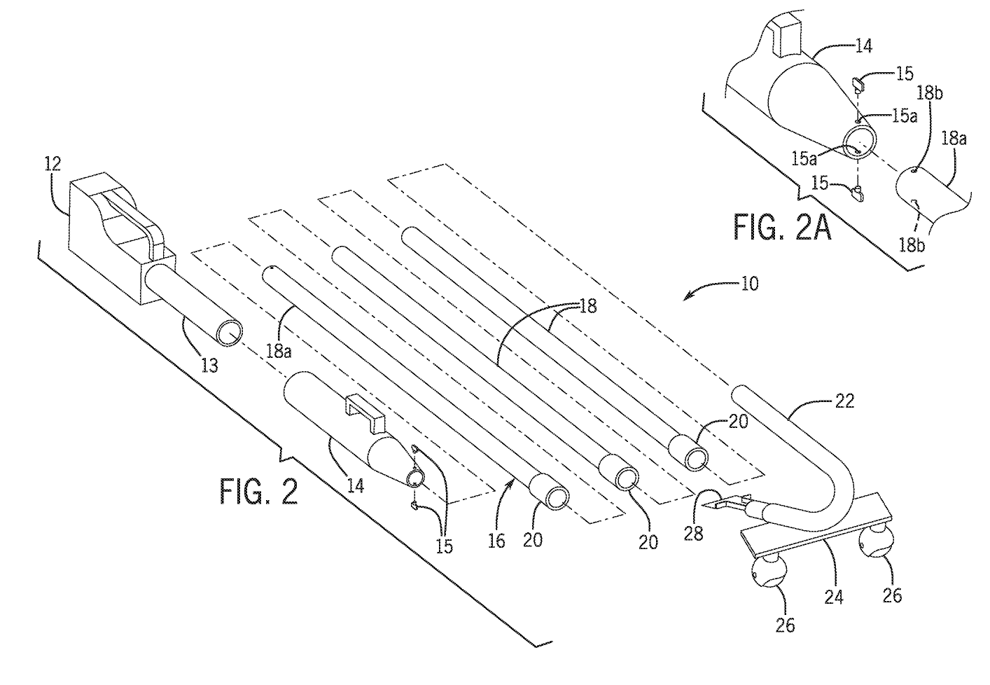

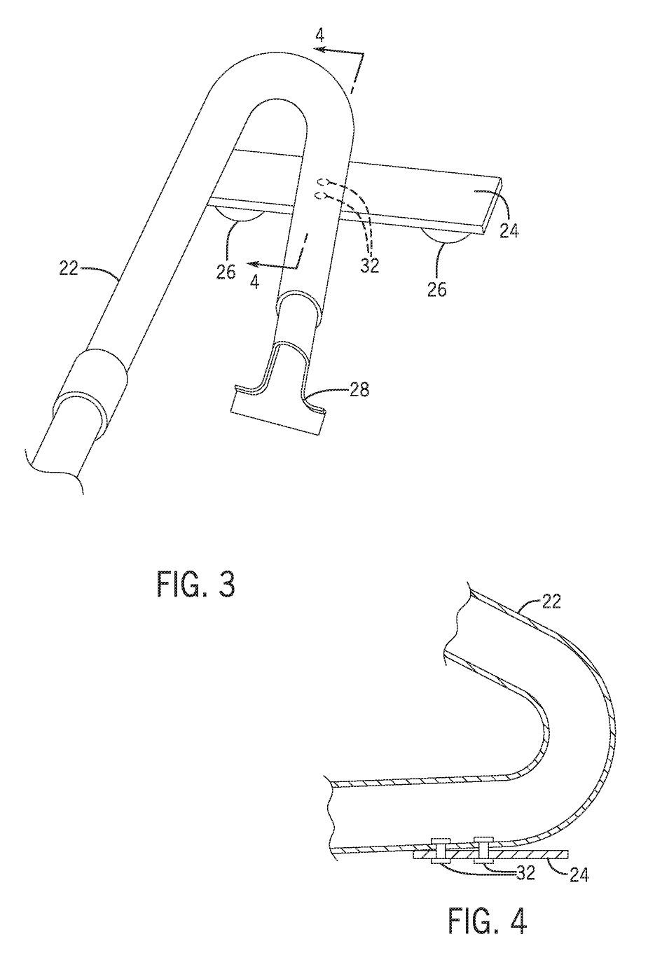

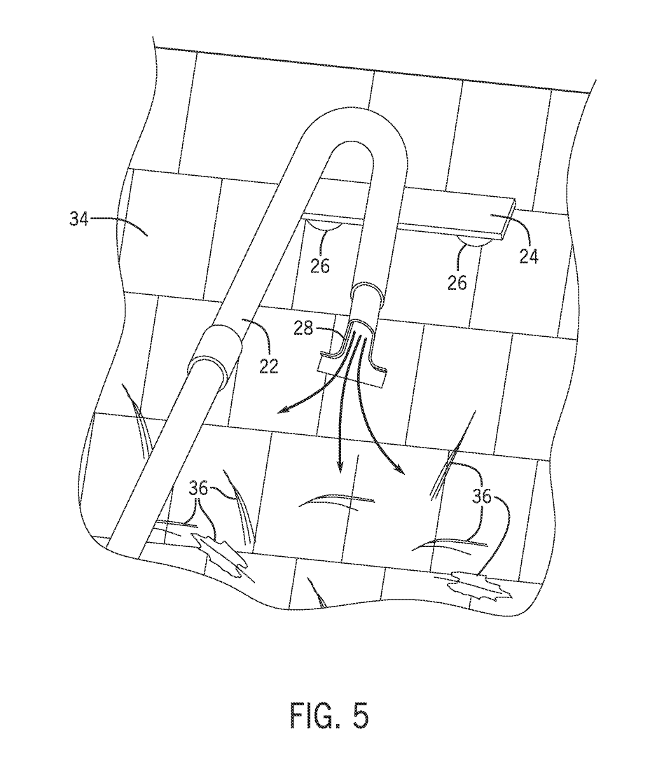

Referring to FIGS. 1 through 5, the present invention includes a roof cleaning device 10. The roof cleaning device 10 includes at least a blower 12 and an elongated tube 16. The blower 12 includes a housing, a motor disposed in the housing, and a blower nozzle 13. The elongated tube 16 includes a proximal end and a distal end. The proximal end is coupled to the blower nozzle 13 to receive the air from the blower 12 and the distal end includes an opening. The motor is operable to propel air out of the nozzle 13, into the elongated tube 16 and out of the opening of the distal end of the elongated tube 16.

The motor may be powered by electricity or gas. When powered, the motor may rotate a fan, which in turn blows air of out of the nozzle 13. In certain embodiments, the present invention may utilize an adapter 14. The adapter 14 may connect a standard leaf blower to the elongated tube 16. In such embodiments, the adapter 14 includes a receiving end to receive and couple to the nozzle 13 of the blower. The adapter 14 may further include a coupling end to couple to the elongated tube 16. The coupling end may include an opening to receive the proximal end of the elongated tube 16. The coupling end may further include a pair of fastener openings 15a. The proximal end of the elongated tube 16 may include a pair of threaded openings 18b that correspond with the pair of fastener openings 15a. Threaded bolts 15 may run through the pair of fastener openings 15a and mechanically fasten to the pair of threaded openings 18b, thereby coupling the elongated tube 16 to the adapter 14.

The present invention may further include a bracket 24 coupled to the distal end of the elongated tube 16 by fasteners 32, such as rivets, bolts, and the like. The bracket 24 may include a plate having an upper surface and a lower surface. The upper surface of bracket 24 is coupled to the distal end of the elongated tube 16. At least one roller 26 is coupled to the lower surface of the bracket 24. For example, a pair of rollers 26 or more may be coupled to the lower surface of the bracket 24. In certain embodiments, the pair of rollers 26 are casters including wheels that rotate about an axle. The rollers 26 allow a user to easily maneuver the present invention along a roof 34.

In certain embodiments, the elongated tube 16 may be formed of a plurality of hollow tube segments 18 releasably coupled together by couplings 20. This allows a user to easily assemble the elongated tube 16 for use and disassemble the elongated tube 16 for storage. Further, this allows the roof cleaning device 10 to be adjustable in length to accommodate different heights of roofs 34 to be cleaned. In such embodiments, the elongated tube 16 includes a plurality of tube segments 18 coupled together in between a proximal tube segment 18a and a distal tube segment 22. The proximal tube segment 18a includes the pair of threaded openings 18b and couples with either the blower 12 or the adapter 14. The bracket 24 is coupled to the distal tube segment 22. In certain embodiments, the distal tube segment 22 may include a bend. The bend may be greater than 90 degrees and may range from more than 90 degrees up to 180 degrees. For example, the bend may be a U-shaped bend at about 140 to about 160 degrees. The bracket 24 is coupled to the distal tube segment 22 beyond the bend. The bend of the distal tube segment 22 allows the openings to face downward and back towards the blower 12. Therefore, when the present invention is in use, the leaves and debris 36 are blown downward and off of the roof 34.

The present invention may further include a tube nozzle 28. The tube nozzle 28 may be coupled within the opening of the distal end of the elongated tube 16. For example, the tube nozzle 28 may be coupled within the distal opening of the distal tube segment 22. The tube nozzle 28 may include a fitting end and a delivery end. The fitting end may include a rounded tube sized to fit within the opening of the distal end of the elongated tube 16. The delivery end extends from the fitting end and may include a flat plate that expands in width at a distal end. Raised lips may be formed at the edges of the flat plate to further direct air blown from the opening of the distal end of the elongated tube 16.

When in use, the nozzle 13 of the motor 12 may be inserted into the adapter 14. The proximal tube segment 18a may be coupled to the adapter 14 by the threaded bolts 15. The plurality of tube segments 18 may be coupled together by the couplings 20, forming the elongated tube 16. The distal tube segment 22 may be coupled to the distal end of the elongated tube 16. When the elongated tube 16 is in the expanded form, the user may begin to clean their roof 34. The user may raise the elongated tube 16 and place the rollers 26 against the upper surface of the roof 34. The user may then turn the blower 12 on, which in turn blows the leaves and debris 36 downward and off of the roof 34. The user may roll the distal end of the elongated tube 16 to different areas of the roof 34 via the rollers 26, thereby enabling the user to clean a substantial portion of the roof 24 using the present invention.

It should be understood, of course, that the foregoing relates to exemplary embodiments of the invention and that modifications may be made without departing from the spirit and scope of the invention as set forth in the following claims.

What is claimed is:

1. A roof cleaning device comprising:
a blower comprising a housing, a motor disposed in the housing, and a blower nozzle, wherein the motor is operable to propel air out of the nozzle;
an elongated tube comprising a proximal end and a distal end, wherein the proximal end is coupled to the blower nozzle to receive the air from the blower and the distal end comprises an opening; and
a bracket coupled to the distal end of the elongated tube, wherein the bracket comprises at least one roller.

2. The roof cleaning device of claim 1, wherein the bracket comprises a plate having an upper surface coupled to the distal end of the elongated tube and a lower surface, wherein the at least one roller is coupled to the lower surface.

3. The roof cleaning device of claim 1, wherein the at least one roller is a pair of rollers.

4. The roof cleaning device of claim 1, wherein the at least one roller is a caster.

5. The roof cleaning device of claim 1, wherein a bend greater than 90 degrees is formed at the distal end of the elongated tube, wherein the bracket is coupled to the distal end beyond the bend.

6. The roof cleaning device of claim 5, wherein the bend is a U-shaped bend.

7. The roof cleaning device of claim 1, wherein the elongated tube is formed of a plurality of hollow tube segments releasably coupled together by couplings.

8. A roof cleaning device comprising:
a blower comprising a housing, a motor disposed in the housing, and a blower nozzle, wherein the motor is operable to propel air out of the nozzle; and
an elongated tube comprising a proximal end and a distal end, wherein the proximal end is coupled to the blower nozzle to receive the air from the blower and the distal end comprises an opening, wherein
a bend greater than 90 degrees is formed at the distal end of the elongated tube.

9. The roof cleaning device of claim 8, further comprising a bracket coupled to the distal end of the elongated tube beyond the bend, wherein the bracket comprises at least one roller.

10. The roof cleaning device of claim 9, wherein the bracket comprises a plate having an upper surface coupled to the distal end of the elongated tube and a lower surface, wherein the at least one roller is coupled to the lower surface.

11. The roof cleaning device of claim 9, wherein the at least one roller is a pair of rollers.

12. The roof cleaning device of claim 9, wherein the at least one roller is a caster.

13. The roof cleaning device of claim 8, wherein the bend is a U-shaped bend.

14. The roof cleaning device of claim 8, wherein the elongated tube is formed of a plurality of hollow tube segments releasably coupled together by couplings.
